(19) United States
(12) Patent Application Publication
(10) Pub. No.: US 2008/0092796 A1
(43) Pub. Date: Apr. 24, 2008

(54) DISPOSABLE FLAG

(76) Inventors: Kenneth T. Laivins, Hebron, OH (US); Glen A. Laivins, Hebron, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/551,933

(22) Filed: Oct. 23, 2006

(51) Int. Cl. G09F 17/00

(52) U.S. Cl. 116/173

(57) ABSTRACT

A disposable flag is disclosed herein. In one embodiment, the flag includes at least one sheet that defines a channel and at least one wing. At least one perforation is disposed across a length of the flag. A user may tear the perforation to separate a first flag from a second flag.

### FIELD OF INVENTION

The present application relates to a disposable flag. In particular, the application relates to a disposable flag or pennant configured to slide over a post or course marker.

### BACKGROUND

Flags, pennants, and banners are commonly used at events such as parties, sporting events, retail sales events, political rallies and elections, and other such short term events. In one known application, flags are used as course markers for motorcycle races, bicycle races, running races, car races, etc. Such flags serve a primary purpose of identifying the boundaries of the course, but may also serve a secondary purpose of providing information, such as advertising information.

Reusable prior art flags and markers have been designed to have substantial resistance to distortion. Such flags are suited for long-term or repeated use, but incur storage costs when not in use. Disposable flags are also known in the prior art. Such flags are typically tied, stapled, nailed, bolted, or otherwise affixed to a permanent structure.

### BRIEF DESCRIPTION OF THE DRAWINGS

The accompanying drawings, together with the detailed description provided below, describe exemplary embodiments of the claimed invention. Like elements are identified with the same reference numerals. The drawings are not to scale and the proportion of certain elements may be exaggerated for the purpose of illustration.

FIGS. 1A-1C are front plan views of exemplary embodiments of a plurality of disposable flags;

FIG. 2 is a top plan view of one embodiment of a flag;

FIGS. 3A-3E are top plan views of exemplary embodiments of assemblies for a disposable flag;

FIG. 4 is a front plan view of one embodiment of a course marker having a disposable flag and a post;

FIG. 5 is a front plan view of an alternative embodiment of a course marker having a disposable flag and a post;

FIGS. 6A-6C are front plan views of alternative embodiments of a plurality of disposable flags;

FIG. 7 is a top plan view of an alternative embodiment of a flag;

FIGS. 8A-8C are top plan views of exemplary embodiments of an assemblies for a disposable flag;

FIG. 9 is a front plan view of an alternative embodiment of a course marker having a disposable flag and a post;

FIG. 10 is a front plan view of an alternative embodiment of a course marker having a disposable flag and a post;

FIG. 11 is one embodiment of a roll of a plurality of disposable flags; and

FIG. 12 is one embodiment of a stack of a plurality of disposable flags.

### DETAILED DESCRIPTION

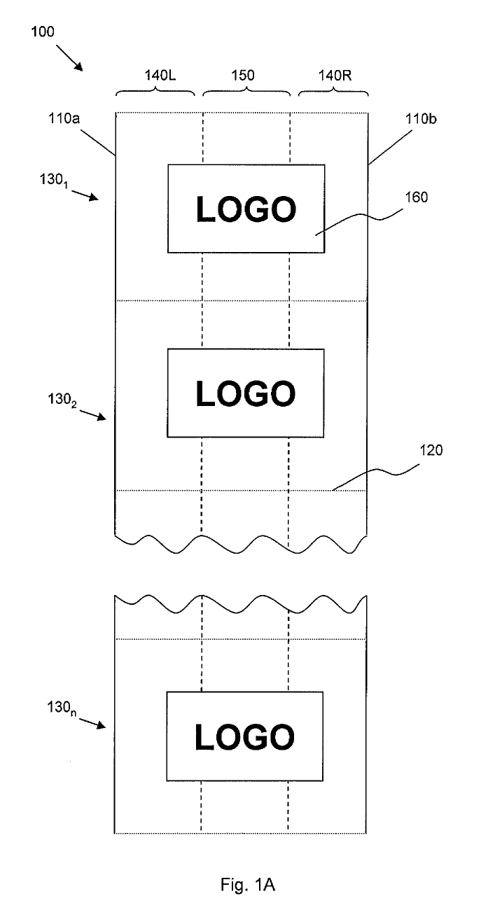

FIG. 1A illustrates a front plan view of a plurality of disposable flags 100. In the illustrated embodiment, the plurality of disposable flags 100 are defined by a first elongated edge 110a, a second elongated edge 110b, and a plurality of perforations 120. Each perforation 120 extends substantially perpendicularly from the first elongated edge 110a to the second elongated edge 110b. The plurality of perforations 120 define a first flag 130₁, a second flag 130₂, . . . , and an n^{th} flag 130ₙ. In the illustrated embodiment, each flag 130 is approximately rectangular and has a width that is greater than the length. In one known embodiment, each flag has a width of about 10 inches to about 12 inches and a length of about 8.5 inches to about 10 inches. In an alternative embodiment (not shown), the length of each flag is greater than the width. In another alternative embodiment (not shown), each flag has a non-rectangular, polygonal shape. In yet another alternative embodiment (not shown), each flag has a round shape.

It should be understood that selected perforations 120 may be torn to make disposable flags of a desired length. For example, in one embodiment, the disposable flag may include only a first flag 130₁. In an alternative embodiment, the disposable flag may include a first flag 130₁ and a second flag 130₂. In other embodiments, the disposable flag may have three or more flags.

With continued reference to FIG. 1A, each of the plurality of flags 100 includes a left wing portion 140L, a right wing portion 140R, and a channel portion 150. In the illustrated embodiment, the channel portion 150 is located in an approximately central position with respect to the first and second elongated edges 110a, 110b. In alternative embodiments, the channel portion is off-center.

Each flag 130 further includes indicia 160. The indicia 160 includes at least one of text or graphics. In one embodiment, the indicia is affixed to a decal, a sticker, or other such adhesive member that is applied to at least one side of each flag 130. In an alternative embodiment, the indicia 160 is printed directly on at least one side of each flag 130. In one embodiment, the indicia 160 is the same on each flag. In an alternative embodiment, the indicia 160 varies.

In an alternative embodiment, illustrated in FIG. 1B, the indicia 160 is only disposed on certain flags 130. Here, the indicia 160 is disposed on every second flag. It should be understood that the indicia 160 may be disposed on the plurality of flags 100 in any pattern.

In another alternative embodiment, illustrated in FIG. 1C, the indicia 160 is larger than a single flag 130 and extends multiple flags 130. Here, each indicia 160 is disposed across two flags 130. In other alternative embodiments (not shown), the indicia extends across three or more flags.

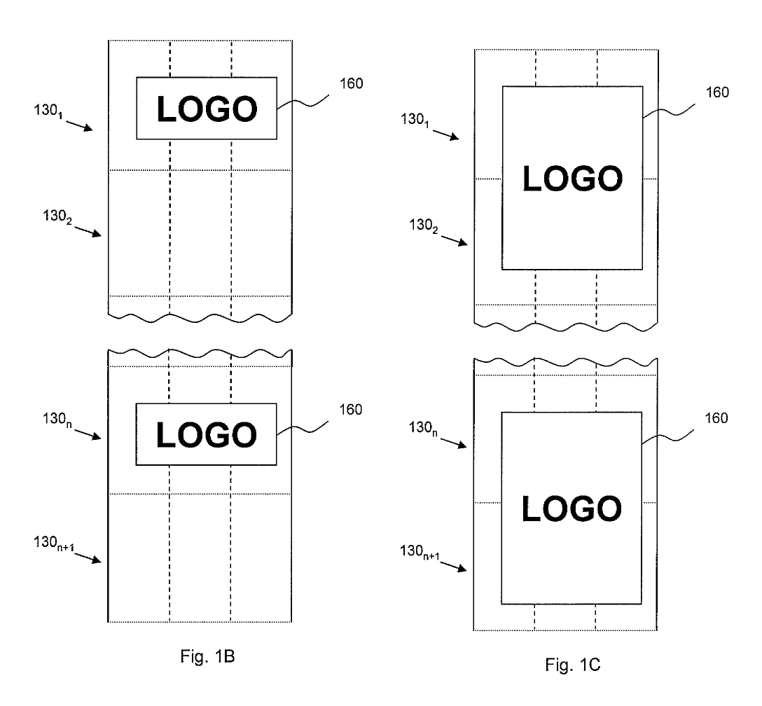

FIG. 2 illustrates a top view of one embodiment of a flag 130. The flag includes a left wing portion 140L, a right wing portion 140R, and a channel portion 150. In the illustrated embodiment, the channel portion 150 is configured to slide over a post or other such structure, and is substantially the same length as the left wing portion 140L and the right wing portion 140R. In alternative embodiments (not shown), the left wing portion 140L and the right wing portion 140R are substantially longer than the channel portion 150. In another alternative embodiment (not shown), the left wing portion 140L is longer than the right wing portion 140R. In yet another alternative embodiment (not shown), the right wing portion 140R is longer than the left wing portion 140L.

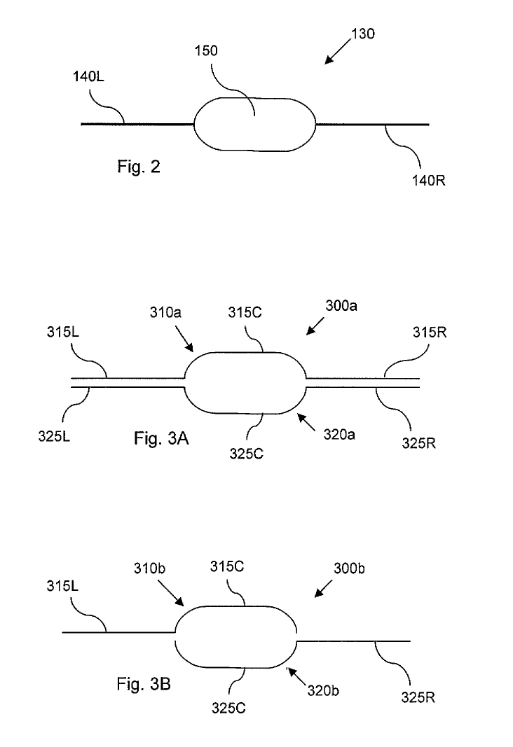

FIG. 3A illustrates one embodiment of an assembly 300a for a disposable flag. The assembly 300a includes a front sheet 310a having a front left portion 315L, a front channel wall portion 315C, and a front right portion 315R. The assembly 300a further includes a back sheet 320a having a back left portion 325L, a back channel wall portion 325C, a back right portion 325R, and a shape corresponding to the shape of the front sheet 310a. In this embodiment, each of the sheets 310a, 320a have a thickness of about 1 mil (0.001 inches) to about 30 mils (0.03 inches) and are constructed of fabric, paper, a polymeric material such as polypropylene, or other such flexible materials. In an alternative embodiment (not shown), the sheets are thicker and more rigid.

In the illustrated embodiment, the front left portion 315L of the front sheet 310a is aligned with the back left portion 325L of the back sheet 320a and joined by an adhesive, a heat seal, or by staples, stitches, or other known attachment means. Similarly, the front right portion 315R of the front sheet 310a is aligned with the back right portion 325R of the back sheet 320a and joined by an adhesive, by a heat seal, or by or by staples, stitches, or other known attachment means. It should be understood that these steps may be performed concurrently, or consecutively in any order.

FIG. 3B illustrates an alternative embodiment of an assembly 300b for a disposable flag. In this embodiment, the assembly 300b includes a front sheet 310b having a front left portion 315L and a front channel wall portion 315C. The assembly 300b further includes a back sheet 320b having a back channel wall portion 325C, a back right portion 325R, and a shape corresponding to the shape of the front sheet 310b. The front and back sheets 310b, 320b have a similar thickness and material as the front and back sheets 310a, 320a described above with respect to FIG. 3A.

In the illustrated embodiment, the end of the front channel wall portion 315C of the front sheet 310b is aligned with the back sheet 320b at a location where the back channel wall portion 325C meets the back right portion 325R. The front and back sheets 310b, 320b are then joined at this location by an adhesive, a heat seal, or by or by staples, stitches, or other known attachment means. Similarly, the end of the back channel wall portion 325C of the back sheet 320b is aligned with the front sheet 310b at the location where the front left portion 315L meets the front channel wall portion 315C. The front and back sheets 310b, 320b are then joined at this location by an adhesive, by a heat seal, or by or by staples, stitches, or other known attachment means. It should be understood that these steps may be performed concurrently, or consecutively in any order.

FIG. 3C illustrates an alternative embodiment of an assembly 300c for a disposable flag. In this embodiment, the assembly 300c includes a front sheet 310c having only a front channel wall portion 315C. The assembly 300c further includes a back sheet 320c having a back left portion 325L, a back channel wall portion 325C, and a back right portion 325R. The front and back sheets 310c, 320c have a similar thickness and material as the front and back sheets 310a, 320a described above with respect to FIG. 3A.

In the illustrated embodiment, the end of the front channel wall portion 315C of the front sheet 310c is aligned with the back channel wall portion 325C of the back sheet 320b. The front and back sheets 310b, 320b are then joined at this location by an adhesive, a heat seal, or by or by staples, stitches, or other known attachment means. It should be understood that these steps may be performed concurrently, or consecutively in any order.

FIG. 3D illustrates an alternative embodiment of an assembly 300d for a disposable flag. In this embodiment, the assembly 300d includes a front sheet 310d and a back sheet 320d. This embodiment is similar to the assembly 300c illustrated in FIG. 3C, except the back sheet 320d has no discernable wing portions or channel wall portions. The front and back sheets 310d, 320d have a similar thickness and material as the front and back sheets 310a, 320a described above with respect to FIG. 3A.

In the illustrated embodiment, the end of the front channel wall portion 315C of the front sheet 310d is aligned with the back sheet 320b. The front and back sheets 310d, 320d are then joined at by an adhesive, a heat seal, or by or by staples, stitches, or other known attachment means. It should be understood that these steps may be performed concurrently, or consecutively in any order.

FIG. 3E illustrates an alternative embodiment of an assembly 300e for a disposable flag. In this embodiment, the assembly 300e includes a single sheet 310e having a front right portion 315R, a front channel wall portion 315C, a front left portion 315L, a back left portion 325L, a back channel wall portion 325C, and a back right portion 325R. The single sheet 310e has a similar thickness and material as the front and back sheets 310a, 320a described above with respect to FIG. 3A.

In the illustrated embodiment, the sheet 310e is folded such that the front left portion 315L is aligned with the back left portion 325L. The two portions are then joined by an adhesive, a heat seal, or by or by staples, stitches, or other known attachment means. Similarly, the front right portion 315R is aligned with the back light portion 325R and joined by an adhesive, by a heat seal, or by or by staples, stitches, or other known attachment means. It should be understood that these steps may be performed concurrently, or consecutively in any order.

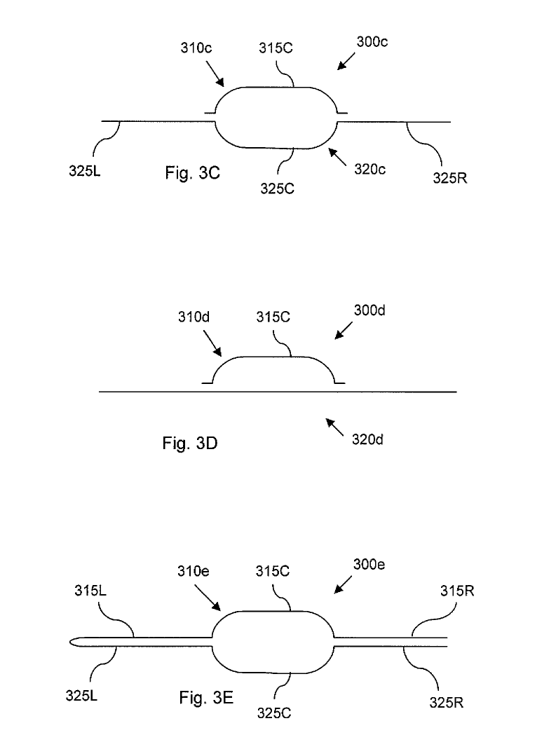

FIG. 4 illustrates one embodiment of a course marker 400 having a post P and a disposable flag consisting of a single flag 130. The disposable flag is created by tearing a single flag 130 from a plurality of flags 100 at a perforation 120.

With continued reference to FIG. 4, the post P may be a permanent structure or a temporary, movable structure. The dimensions of the channel portion 150 of the disposable flag correspond to the dimensions of the post P such that the channel portion 150 the disposable flag is configured to slide over the post P. The disposable flag is oriented on the post P such that the indicia 160 is visible and the left wing portion 140L and the right wing portion 140R extend from opposite sides of the post P.

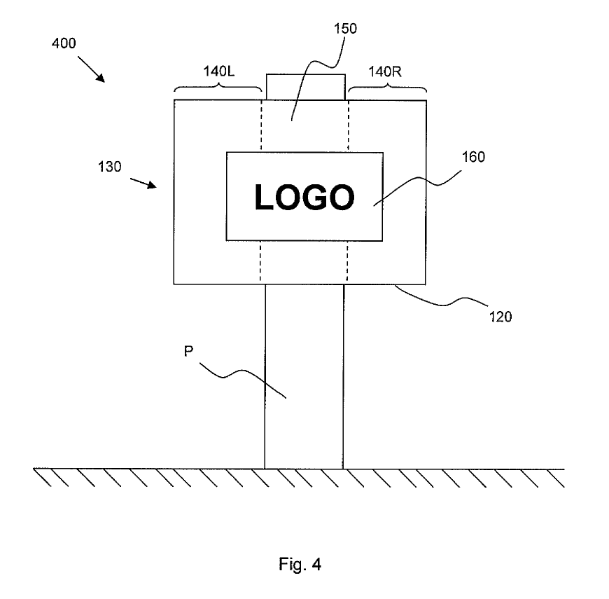

FIG. 5 illustrates an alternative embodiment of a course marker 500 having a post P and a disposable flag consisting of multiple flags. In the illustrated embodiment, the disposable flag consists of a first flag 130₁ and a second flag 130₂. The disposable flag is created by tearing the first and second flags 130₁, 130₂ from a plurality of flags 100 at a perforation 120. In alternative embodiments (not shown), the disposable flag includes three or more flags.

With continued reference to FIG. 5, the post P may be a permanent structure or a temporary, movable structure. The dimensions of the channel portion 150 of the disposable flag correspond to the dimensions of the post P such that the channel portion 150 the disposable flag is configured to slide over the post P. The disposable flag is oriented on the post P such that the indicia 160 is visible and the left wing portion 140L and the right wing portion 140R extend from opposite sides of the post P.

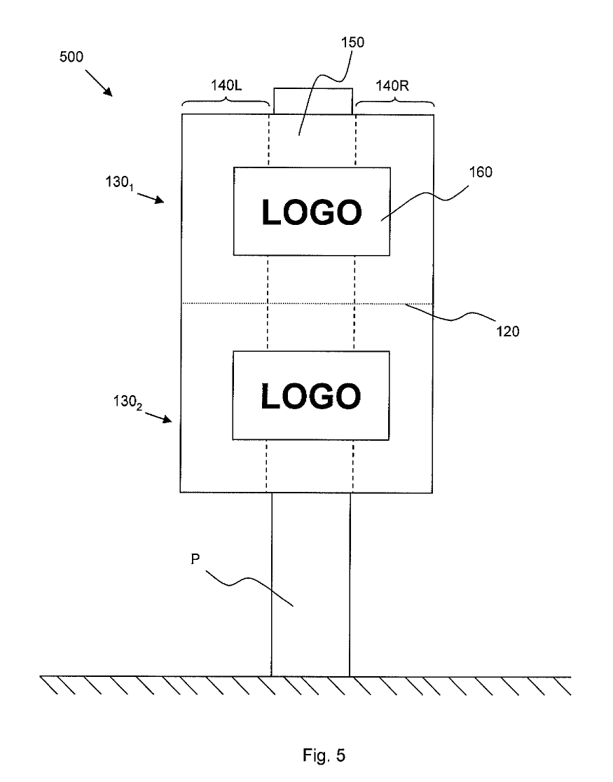

With attention now to FIG. 6A, an alternative embodiment of a plurality of disposable flags 600 is illustrated. In this embodiment, the plurality of disposable flags 600 are defined by a first elongated edge 610a, a second elongated edge 610b, and a plurality of perforations 620. Each perforation 620 extends substantially perpendicularly from the first elongated edge 610a to the second elongated edge 610b. The plurality of perforations 620 define a first flag 630₁, a second flag 630₂, . . . , and an n^{th} flag 630ₙ. In the illustrated embodiment, each flag 630 is approximately rectangular and has a width that is greater than the length. In one known embodiment, each flag has a width of about 10 inches to about 12 inches and a length of about 8.5 inches to about 10 inches. In alternative embodiments (not shown) the length of each flag is greater than the width. In another alternative embodiment (not shown), each flag has a non-rectangular, polygonal shape. In yet another alternative embodiment (not shown), each flag has a round shape.

It should be understood that selected perforations 620 may be torn to make disposable flags of a desired length. For example, in one embodiment, the disposable flag may include only a first flag 630₁. In an alternative embodiment, the disposable flag may include a first flag 630₁ and a second flag 630₂. In other embodiments, the disposable flag may have any three or more portions.

With continued reference to FIG. 6A, each of the plurality of flags 600 includes a wing portion 640 and a channel portion 650. In the illustrated embodiment, the channel portion 650 is located on the left side of the plurality of disposable flags 600. In alternative embodiments, the channel portion is located on the right side of the plurality of disposable flags 600.

Each flag 630 further includes indicia 660. The indicia 660 includes at least one of text or graphics. In one embodiment, the indicia is affixed to a decal, a sticker, or other such adhesive member that is applied to at least one side of each flag 630. In an alternative embodiment, the indicia 660 is printed directly on at least one side of each flag 630. In one embodiment, the indicia 660 is the same on each flag. In an alternative embodiment, the indicia 660 varies.

In an alternative embodiment, illustrated in FIG. 6B, the indicia 660 is only disposed on certain flags 630. Here, the indicia 660 is disposed on every second flag. It should be understood that the indicia 660 may be disposed on the plurality of flags 100 in any pattern.

In another alternative embodiment, illustrated in FIG. 6C, the indicia 660 is larger than a single flag 630 and extends multiple flags 630. Here, each indicia 660 is disposed across two flags 630. In other alternative embodiments (not shown), the indicia extends across three or more flags.

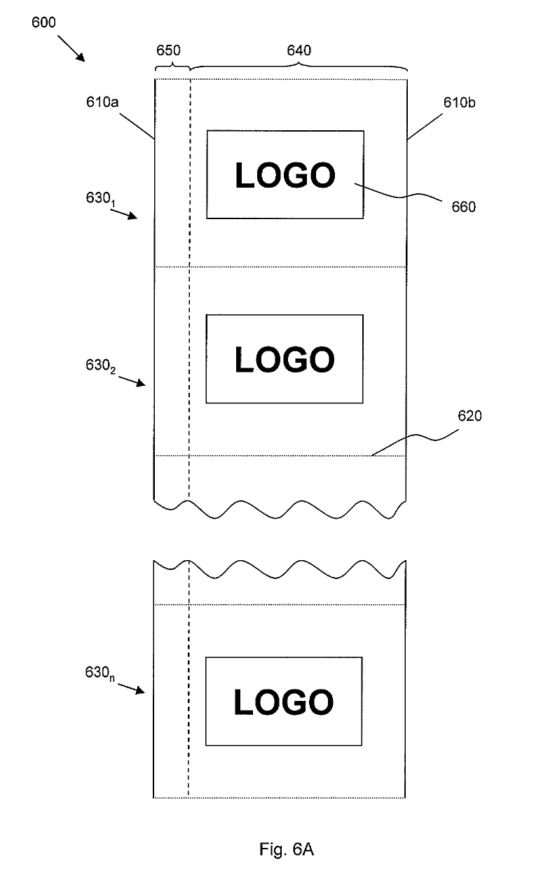

FIG. 7 illustrates a top view of one embodiment of a flag 630. The flag 630 includes a wing portion 640 and a channel portion 650. In the illustrated embodiment, the channel portion 650 is configured to slide over a post or other such structure, and has a shorter length than the wing portion 640. In an alternative embodiment (not shown), the wing portion 640 and the channel portion 650 are substantially the same length.

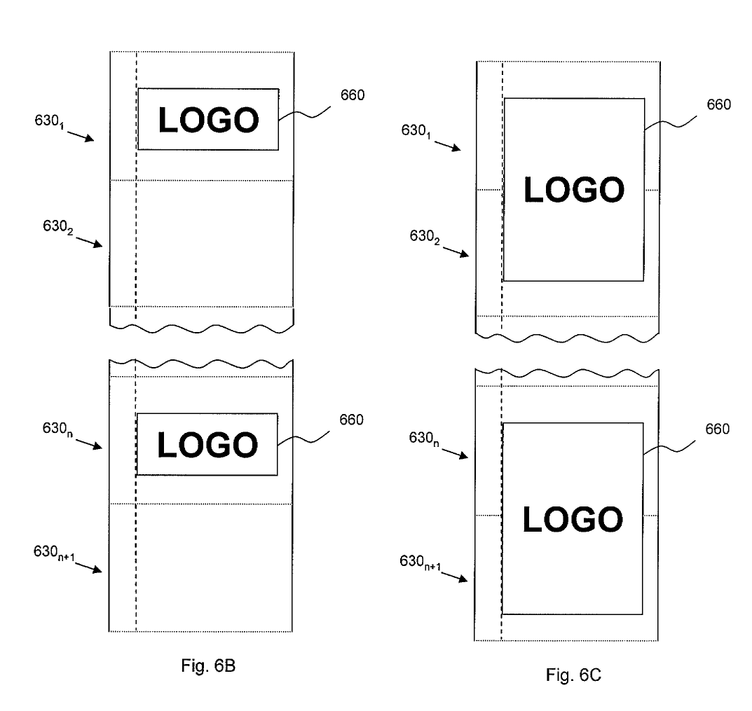

FIG. 8A illustrates one embodiment of an assembly 800a for a disposable flag. The assembly 800a includes a front sheet 810a having a front channel wall portion 815C, and a front right portion 815R. The assembly 800a further includes a back sheet 820a having a back channel wall portion 825C, a back right portion 825R, and a shape corresponding to the shape of the front sheet 810a. In this embodiment, each of the sheets 810a, 820a have a thickness of about 1 mil (0.001 inches) to about 30 mils (0.03 inches) and are constructed of fabric, paper, a polymeric material such as polypropylene, or other such flexible materials. In an alternative embodiment (not shown), the sheets are thicker and more rigid.

In the illustrated embodiment, the front channel wall portion 815C of the front sheet 810a is aligned with the back channel wall portion 825C of the back sheet 820a and the ends are joined by an adhesive, a heat seal, or by staples, stitches, or other known attachment means. Similarly, the front right portion 815R of the front sheet 810a is aligned with the back right portion 825R of the back sheet 820a and joined by an adhesive, by a heat seal, or by staples, stitches, or other known attachment means. It should be understood that these steps may be performed concurrently, or consecutively in any order.

FIG. 8B illustrates an alternative embodiment of an assembly 800b for a disposable flag. In this embodiment, the assembly 800b includes a single sheet 810b having a front right portion 815R, a front channel wall portion 815C, a back channel wall portion 825C, and a back right portion 825R. The sheets 810b has a similar thickness and construction as the front and back sheets 310a, 310b described above with respect to FIG. 8A.

In the illustrated embodiment, the single sheet 810b is folded such that the front channel wall portion 815C is aligned with the back channel wall portion 825C and the front right portion 815R is aligned with the back right portion 825R. The front right portion 815R is then joined to the back right portion 825R by an adhesive, by a heat seal, or by staples, stitches, or other known attachment means.

FIG. 8C illustrates an alternative embodiment of an assembly 800c for a disposable flag. In this embodiment, the assembly 800c includes a single sheet 810c having a front right portion 815R, a front channel wall portion 815C, and a back channel wall portion 825C. The single sheet 820c has a similar thickness and construction as the front and back sheets 810a, 810b described above with respect to FIG. 8A.

In the illustrated embodiment, the sheet 810c is folded such that the end of the back channel wall portion 825C is aligned at the location where the front right portion 815R meets the front channel wall portion 815C. The end of the back channel wall portion 825C is then joined to the sheet 810c at this location by an adhesive, by a heat seal, or by staples, stitches, or other known attachment means.

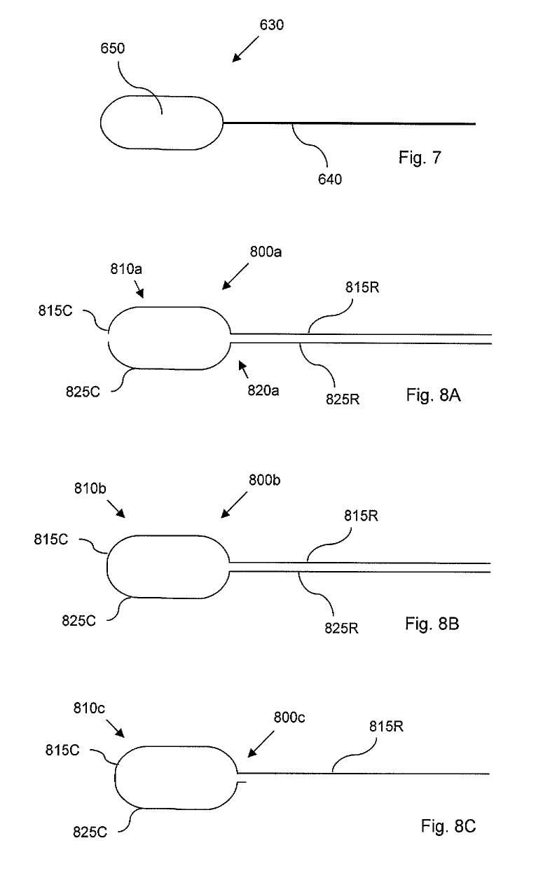

FIG. 9 illustrates one embodiment of a course marker 900 having a post P and a disposable flag consisting of a single flag 630. The disposable flag is created by tearing a single flag 630 from a plurality of flags 600 at a perforation 620.

With continued reference to FIG. 9, the post P may be a permanent structure or a temporary, movable structure. The dimensions of the channel portion 650 of the disposable flag correspond to the dimensions of the post P such that the channel portion 650 the disposable flag is configured to slide over the post P. The disposable flag is oriented on the post P such that the indicia 660 is visible and the wing portion 640 extends from the post P.

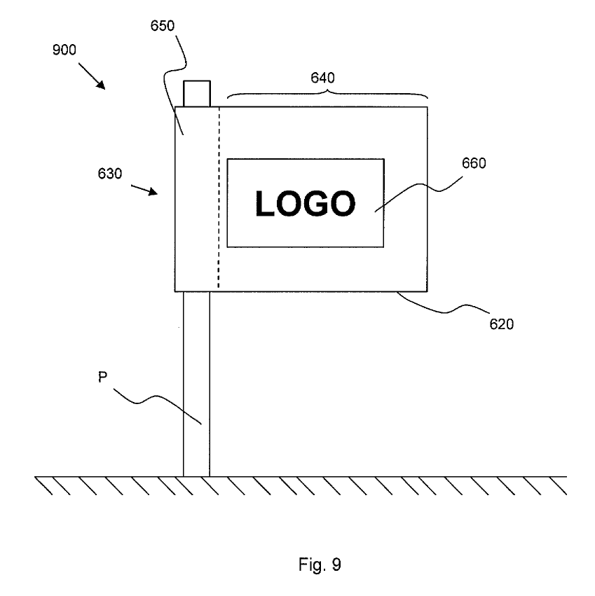

FIG. 10 illustrates an alternative embodiment of a course marker 1000 having a post P and a disposable flag consisting of multiple flags. In the illustrated embodiment, the disposable flag consists of a first flag 630₁ and a second flag 630₂. The disposable flag is created by tearing the first and second flags 630₁, 630₂ from a plurality of flags 600 at a perforation 620. In alternative embodiments (not shown), the disposable flag includes three or more flags.

With continued reference to FIG. 10, the post P may be a permanent structure or a temporary, movable structure. The dimensions of the channel portion 650 of the disposable flag correspond to the dimensions of the post P such that the channel portion 650 the disposable flag is configured to slide over the post P. The disposable flag is oriented on the post P such that the indicia 660 is visible and the wing portion 640 extends from the post P.

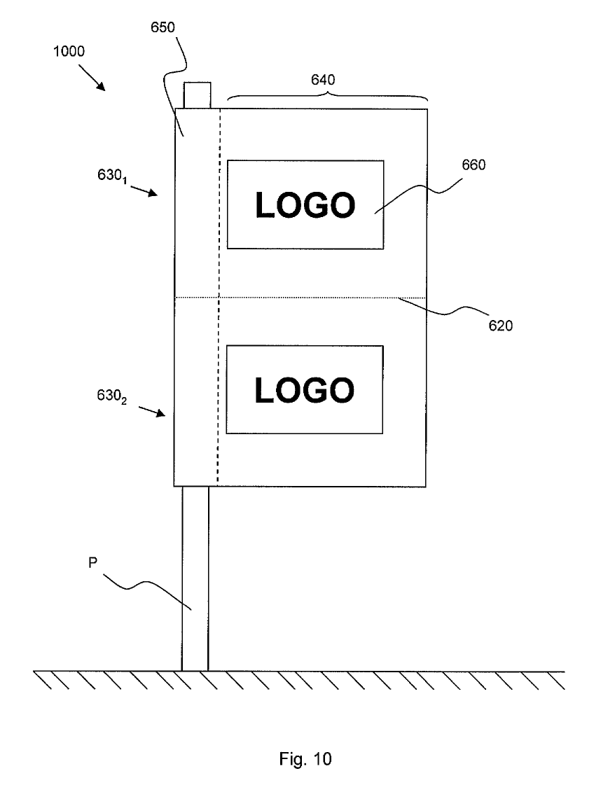

FIG. 11 illustrates one embodiment of a roll of disposable flags 1100. In this embodiment, the disposable flags are sufficiently thin and flexible to be stored in a roll 1100. Such a configuration allows for easy transport and storage of unused flags. In this embodiment, flags having a central channel are illustrated. In alternative embodiments, the flags may have an off-center channel or a channel disposed on the right or left side.

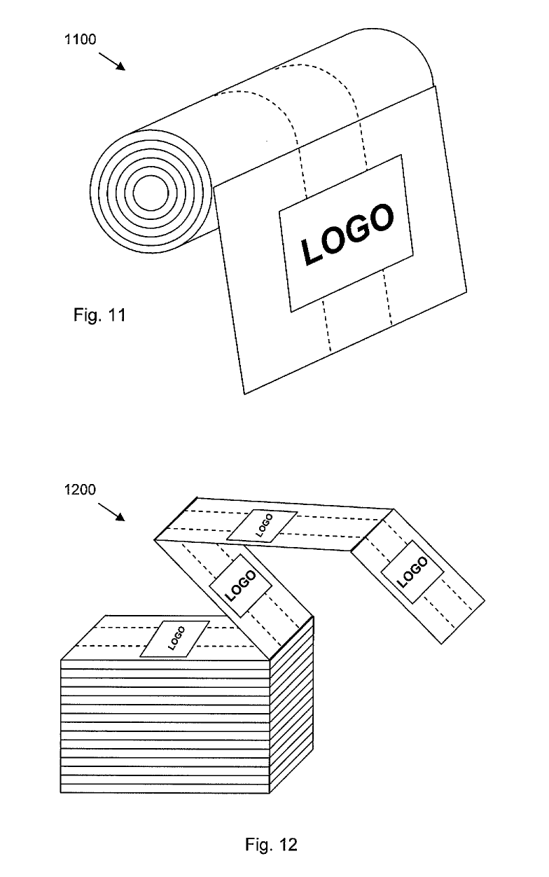

FIG. 12 illustrates one embodiment of a stack of disposable flags 1200. Stacking the flags in this manner allows for easy transport and storage of unused flags. In this embodiment, flags having a central channel are illustrated. In alternative embodiments, the flags may have an off-center channel or a channel disposed on the right or left side.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A disposable flag comprising:
a first flexible sheet having at least two elongated edges;
a second flexible sheet having at least two elongated edges corresponding to the at least two elongated edges of the first flexible sheet, wherein the at least two elongated edges of the first flexible sheet are joined to the at least two elongated edges of the second flexible sheet, thereby forming at least a left wing portion, a right wing portion, and a channel portion; and
at least one perforation dividing the flag into at least a first left wing portion, a second left wing portion, a first right wing portion, a second right wing portion, a first channel portion, and second channel portion.

2. The disposable flag of claim 1, wherein the first and second flexible sheets are polygonal.

3. The disposable flag of claim 2, wherein the first and second flexible sheets are rectangular.

4. The disposable flag of claim 1, wherein the first and second flexible sheets are round.

5. The disposable flag of claim 1, wherein each of the first and second flexible sheets has a thickness of about 0.001 inches to about 0.03 inches.

6. The disposable flag of claim 1, wherein the at least two elongated edges of the first flexible sheet are substantially parallel to each other, the at least two elongated edges of the second flexible sheet are substantially parallel to each other, and the at least one perforation is substantially orthogonal to the at least two edges of the first flexible sheet and the at least two edges of the second flexible sheet.

7. The disposable flag of claim 1, further comprising at least one adhesive member displaying indicia.

8. The disposable flag of claim 1, wherein indicia is printed on the first flexible sheet.

9. The disposable flag of claim 1, wherein the channel portion is configured to slide over a post.

10. A roll of disposable flags comprising:
at least one elongated sheet defining an elongated channel, the at least one elongated sheet having at least a first elongated edge and a second elongated edge and further having a plurality of perforations defining a plurality of flags, wherein each perforation extends across the at least one elongated sheet from the first edge to the second edge.

11. The roll of disposable flags of claim 10, wherein each perforation defines an end of a flag.

12. The roll of disposable flags of claim 10, wherein the at least one elongated sheet includes a first elongated sheet and a second elongated sheet.

13. The roll of disposable flags of claim 12, wherein the first elongated sheet and the second elongated sheet further define a left wing and a right wing.

14. The roll of disposable flags of claim 13, wherein the elongated channel is disposed between the left wing and the right wing.

15. The roll of disposable flags of claim 10, wherein the at least one elongated sheet is a single elongated sheet.

16. The roll of disposable flags of claim 10, wherein the at least one elongated sheet is constructed of a polymeric material.

17. The roll of disposable flags of claim 10, wherein the at least one elongated sheet is constructed of fabric.

18. A flag configured to slide over a post and having an adjustable length, the flag comprising:
at least one sheet defining a channel and at least one wing;
at least one perforation disposed across a length of the flag and configured to allow a user to separate a first flag from a second flag.

19. The flag of claim 18, wherein the at least one sheet includes at least a first sheet and a second sheet, defining a left wing and a right wing.

20. The flag of claim 18, wherein the at least one sheet is a single sheet.

21. The flag of claim 18, wherein the flag is configured to display at least one of text and graphics.
